(19) United States
(12) Patent Application Publication
(10) Pub. No.: US 2010/0039031 A1
(43) Pub. Date: Feb. 18, 2010

(54) Electroluminescent Lamp

(75) Inventors: Michael Zeng, Guangdong (CN); Jacky Chen, Guangdong (CN); Ky Lee, Guangdong (CN)

Correspondence Address: MOLEX INCORPORATED, 2222 WELLINGTON COURT, LISLE, IL, 60532, US

(73) Assignee: Molex Incorporated, Lisle, IL (US)

(21) Appl. No.: 12/086,068

(22) PCT Filed: Dec. 8, 2006
(86) PCT No.: PCT/US2006/046094

§ 371 Date: Nov. 2, 2009

(30) Foreign Application Priority Data
Dec. 8, 2005 (CN) 200510130062.5

(51) Int. Cl. H01J 1/62

(52) U.S. Cl. 313/509

(57) ABSTRACT

An electroluminescent lamp comprises a substrate, an electroluminescent system printed on the substrate and a protection layer covering the outer surface of the electroluminescent system. The electroluminescent system comprises two electrode layers, where a dielectric layer and electroluminescent layer placed there between. The protection layer and the substrate interconnecting to form an envelope layer sealing the electroluminescent system, isolating the electroluminescent system inside the substrate and the protection layer. There is an adhesive layer beneath the substrate. It is also disclosed here a combination of an electroluminescent lamp and a metal dome sheet. There is a metal dome sheet beneath the adhesive layer. The metal dome sheet comprises a spacer where several receiving-grooves are provided and several metal domes seated respectively within the receiving-grooves. There is a second adhesive layer beneath the spacer. This invention has a simple structure and is easy to assemble.

### FIELD OF INVENTION

This invention relates to an electroluminescent lamp (EL), a combination of the electroluminescent lamp and a metal dome sheet and the method of producing the two products above and, particularly, to an electroluminescent lamp easy to be pasted onto an electrical component and its manufacturing method, also to a combination of a electroluminescent lamp easy to be pasted onto a circuit board and a metal dome sheet and its manufacturing method.

### BACKGROUND OF THE INVENTION

More and more high-tech products are in common use nowadays. Electroluminescent technology previously only for airplane cab application is now widely used in common electrical products such as cell phone, pager, wireless phone, PDA, remote control, etc. Because it has a small size, low weight, low temperature, power efficiency, no flash and consistent luminescence, electroluminescent lamp is gradually taking the place of traditional back-light Low Emitting Diode (LED)

FIG. 6 shows an electroluminescent system in monolithic structure disclosed in U.S. Pat. No. 5,856,029. The electroluminescent lamp disclosed comprises a rear electrode 16, a dielectric layer 15, a luminescent layer 14, a translucent electrode 13, a cover 12 and a bus bar 11. During operation, the rear electrode 16 is deposited_on a substrate 17 which is a textile substrate such as clothes. Subsequently, the dielectric layer 15, luminescent layer 14 and translucent electrode 13 are deposited in turn. The bus bar 11 is printed on the translucent electrode 13 subsequent to the depositing of translucent electrode 13 on luminescent layer 14. Finally, the cover 12 is deposited with connection to the substrate 17. As described above, the electroluminescent lamp is deposited directly on the final product such as clothes. However, if the electroluminescent lamp is deposited by similar method directly on electrical products, electrical products can hardly survive the high temperature and baking environment and device, which significantly brings trouble to manufacturing. Therefore, it is necessary to produce electroluminescent system as an independent product, then paste it to electrical products.

With further reference now to FIGS. 7 and 8, Chinese Patent Application No. 99125456.2 (corresponding to U.S. Pat. No. 5,856,030 and No. 6,270,834) disclosed a method to manufacture an electroluminescent lamp. The electroluminescent lamp comprises a transfer release paper 102, a first envelop layer 104, a ITO 106, a front bus bar 107, an electroluminescent layer 108, a dielectric layer 110, a rear electrode layer 112 and a second envelop layer 114. During printing, the transfer release paper 102 is used as a substrate, all the other layers are printed on the transfer release paper 102 in turn, therefore, the electroluminescent lamp is produced as an independent product. However, when combining the electroluminescent lamp to an electrical product, an adhesive layer 116 should be coated down onto the second envelope layer 114. Then paste the adhesive layer 116 onto an electrical product and remove the transfer release paper 102 to successfully paste the electroluminescent lamp to electrical products. This type of electroluminescent lamp requires two envelop layers printed and an additional adhesive layer 116 when used. It is very inconvenient during application.

During the application of the above-said electroluminescent lamp in cell phone manufacturing, an adhesive layer 116 should be coated to stick the electroluminescent lamp to metal dome sheet. Then the transfer release paper 102 is removed and an adhesive layer is additionally coated on the undersurface of the metal dome sheet which is then mounted onto the circuit board of the cell phone to form a back light dome sheet. The whole process comprises multiple steps of combination and coating so it is very complicated. The resulting quality is also highly un-steady. Therefore, it is necessary to produce an independent product combining the electroluminescent lamp and the metal dome sheet. Such kind of product is easy to be assembled to a circuit board and eases the mounting of the electroluminescent lamp and the metal dome sheet to the circuit board.

### BRIEF SUMMARY OF THE INVENTION

The object of this invention is to provide an electroluminescent lamp and its manufacturing method. An envelope layer in the prior art can be omitted in this electroluminescent lamp. So manufacturing and material used are simplified. No adhesive layer is required when sticking the lamp to other components, which is convenient and time-efficient.

Another object of this invention is to provide a combination of an electroluminescent lamp and a metal dome sheet and its manufacturing method. An envelop layer in the prior art can be omitted in this electroluminescent lamp. So manufacturing and material used are simplified. The possibility to provide combination of an electroluminescent lamp and a metal dome sheet eases the mounting of the electroluminescent lamp and the metal dome sheet to the circuit board. So manufacturing is simplified and the quality is kept consistent.

To achieve the above objects, it is provided in this invention an electroluminescent lamp comprising a substrate, an electroluminescent system printed on the substrate and a protection layer covering the outer surface of the electroluminescent system. The electroluminescent system comprises two electrode layers, where a dielectric layer and electroluminescent layer placed there between. The protection layer and the substrate interconnected to form an envelope layer sealing the electroluminescent system, isolating the electroluminescent system inside the substrate and the protection layer. There is an adhesive layer beneath the substrate and a release paper beneath the adhesive layer, protecting the adhesive layer from outside pollution. The release paper is removed when assembly to stick the electroluminescent lamp directly onto other electrical components.

It is provided in this invention a combination of an electroluminescent lamp and a metal dome sheet. The electroluminescent lamp comprises a substrate, an electroluminescent system printed on the substrate and a protection layer covering the outer surface of the electroluminescent system. The electroluminescent system comprises two electrode layers, where a dielectric layer and electroluminescent layer placed there between. The protection layer and the substrate are interconnected to form an envelope layer sealing the electroluminescent system, isolating the electroluminescent system inside the substrate and the protection layer. There is an adhesive layer beneath the substrate. There is a metal dome sheet beneath the adhesive layer. The metal dome sheet comprises a spacer where several receiving-grooves are provided and several metal domes seated respectively within the receiving-grooves. There is a second adhesive layer beneath the spacer and a release paper is placed beneath the adhesive layer to protect the second adhesive layer from outside pollution. The release paper is removed during assembly to expose the second adhesive layer so that the combination of the electroluminescent lamp and metal dome sheet is sticked directly onto a circuit board.

It is also provided in this invention a method to manufacture the electroluminescent lamp. The method comprises:
1) Providing a substrate with an adhesive layer placed underneath;
2) Super-printing an electroluminescent system on the top surface of the substrate; and
3) Printing a protection layer on the outer surface of the electroluminescent system, the protection layer covering the outer surface of the electroluminescent system and sticking onto the substrate to serve as an envelope layer sealing the electroluminescent system;

It is also provided in this invention a method to manufacture a combination of an electroluminescent lamp and a metal dome sheet. The method comprises:
1) Providing a substrate with a first adhesive layer placed underneath;
2) Super-printing an electroluminescent system on the top surface of the substrate;
3) Printing a protection layer on the outer surface of the electroluminescent system, the protection layer covering the outer surface of the electroluminescent system and sticking onto the substrate to serve as an envelope layer sealing the electroluminescent system;
4) Mounting a metal dome sheet beneath the adhesive layer, the metal dome sheet comprising a spacer where several receiving-grooves are provided and several metal domes seated respectively within the receiving-grooves. Mounting a second adhesive layer beneath the spacer of the metal dome sheet.

The advantages of this invention are as follows: The protection layer of the electroluminescent lamp is stuck onto the substrate, leaving the electroluminescent system there between safely sealed and free of water and dust. The substrate may be mounted onto another products without being removed, therefore, an envelope layer in the prior art can be omitted in this electroluminescent lamp. So manufacturing and material used are simplified. Because of the adhesive protection layer, the electroluminescent lamp may be transported as an independent product. During assembly, the electroluminescent lamp can be stuck directly onto other electrical components after the adhesive protection layer is removed. No additional adhesive layer is required as in prior art, which is convenient and time-efficient. Moreover, there is an adhesive protection layer in the combination of an electroluminescent lamp and a metal dome sheet. So the combination of an electroluminescent lamp and a metal dome sheet may be transported as an independent product. During assembly, the combination of an electroluminescent lamp and a metal dome sheet can be stuck directly onto other electrical components after the adhesive protection layer is removed, which is convenient and fast.

### BRIEF DESCRIPTION OF THE DRAWINGS

FIG. 1 is a perspective view of the electroluminescent lamp according to this invention;

FIG. 2 is a sectional view of FIG. 1;

FIG. 3 is a perspective view of the combination of an electroluminescent lamp and a metal dome sheet according to this invention;

FIG. 4 is a sectional view of FIG. 3;

FIG. 5 is a schematic view of a metal dome sheet according to this invention;

FIG. 6 is a sectional view of a prior art electroluminescent lamp;

FIG. 7 is a perspective view of another prior art electroluminescent lamp;

FIG. 8 is a sectional view of FIG. 7.

### DESCRIPTION OF THE PREFERRED EMBODIMENTS

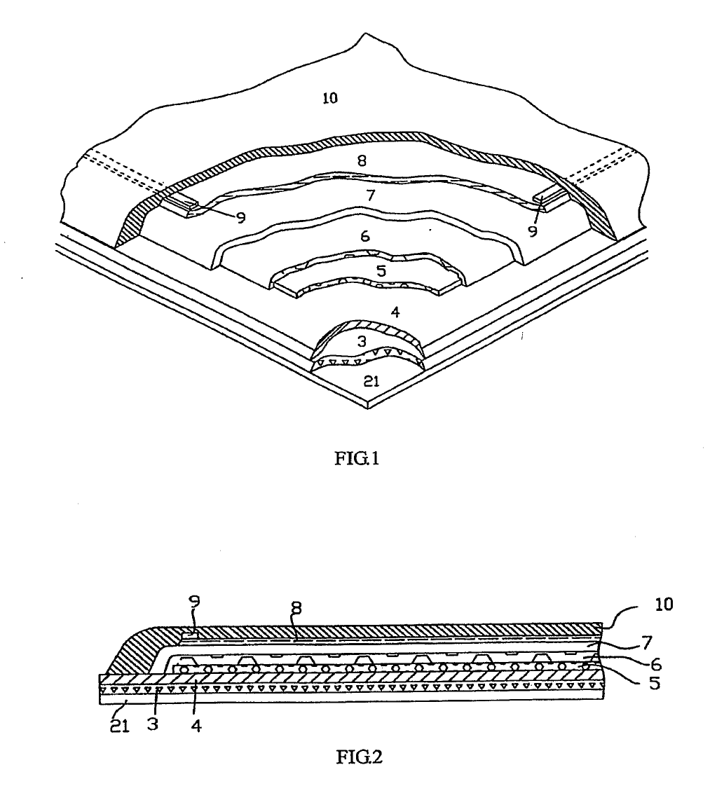

First referring to FIGS. 1 and 2, an electroluminescent lamp is disclosed, which can be assembled onto an electrical component. In this embodiment, the electrical component is a back light dome sheet of a cell phone or other personal communication instruments (Not shown here).

It is provided in this invention an electroluminescent lamp comprising an rear adhesive protection layer 21, a first adhesive layer 3, a substrate 4, a rear electrode layer 5, a dielectric layer 6, an electroluminescent layer 7, a front electrode layer 8, a bus bar 9 and a protection layer 10, from up to down, respectively.

The electroluminescent system of the electroluminescent lamp comprises the rear electrode layer 5, the front electrode layer 8 and the bus bar 9, together with the dielectric layer 6 and the electroluminescent layer 7 placed there between. Screen printing is applied in this invention to super-print the layers of the electroluminescent system onto the substrate 4. Roller printing or any other techniques may also be used.

The substrate 4 is composed of polyester which is a soft and elastic sheet. Because the substrate 4 has high tensile strength, the electroluminescent lamp is hard to be worn.

The rear electrode layer 5 is formed by super-printing a layer of opaque conductive ink onto the substrate 4. Preferably, the conductive ink is silver ink or carbon ink.

The dielectric layer 6 is of high insulation. It is formed by printing insulation ink such as barium titanate onto the rear electrode layer 5.

The electroluminescent layer 7 is formed by super-printing a mixture of phosphor powder and glue onto the dielectric layer 6. The phosphor powder in the electroluminescent layer 7 is actuated by alternating electric field and shines after AC is conducted into the rear electrode layer 5 and the front electrode layer 8 of the electroluminescent lamp.

The front electrode layer 8 is formed by super-printing a layer of transparent or translucent conductive ink onto the electroluminescent layer 7. Preferably, the front electrode layer 8 is printed by conductive ink such as indium tin oxide (ITO).

The bus bar 9 is formed by printing silver-containing ink onto the front electrode layer 8, which is in the form of a circle of thin line surrounding the top surface of the front electrode layer 8. The bus bar 9 can enhance the conductivity of the front electrode layer 8.

The protection layer 10 is formed by printing water resistant and dust resistant ink, such as polyurethane onto the bus bar 9. This layer 10 covers the out surface of the electroluminescent system and is stuck to the substrate 4 as an envelope layer of the electroluminescent system. Therefore, the electroluminescent system wrapped wherein is safely sealed and the electroluminescent lamp is free of air, water and dust and has a long shining duration.

The first adhesive layer 3 is a layer of dryless glue coated directly onto the lower surface of the substrate 4 and placed over the rear adhesive protection layer 21.

The rear adhesive protection layer 21 is on the bottom and designed in the form of a release paper. The rear adhesive protection layer 21 is placed under the first adhesive layer 3 to protect it from outside pollution. The release paper could be removed during assembly to expose the first adhesive layer 3 thus the electroluminescent lamp can be stuck onto electrical products.

The electroluminescent lamp is formed by direct printing the electroluminescent system and protection layer 10 onto the substrate 4 of which the first adhesive layer 3 and the rear adhesive protection layer 21 has been placed on the lower surface. Alternatively, the first adhesive layer 3 and the rear adhesive protection layer 21 may be assembled after the electroluminescent system and protection layer 10 are printed onto the substrate 4.

The protection layer 10 of the electroluminescent lamp is stuck onto the substrate 4, leaving the electroluminescent system therebetween safely sealed and free of water and dust. The substrate 4 may be mounted onto another products without being removed, therefore, an envelope layer in the prior art can be omitted in this electroluminescent lamp. So manufacturing and material used are simplified. Because of the adhesive protection layer 21, the electroluminescent lamp may be transported as an independent product. During assembly, the electroluminescent lamp can be stuck directly onto other electrical components after the adhesive protection layer 21 is removed, and no additional adhesive layer is required as in prior art, which is convenient and time-efficient.

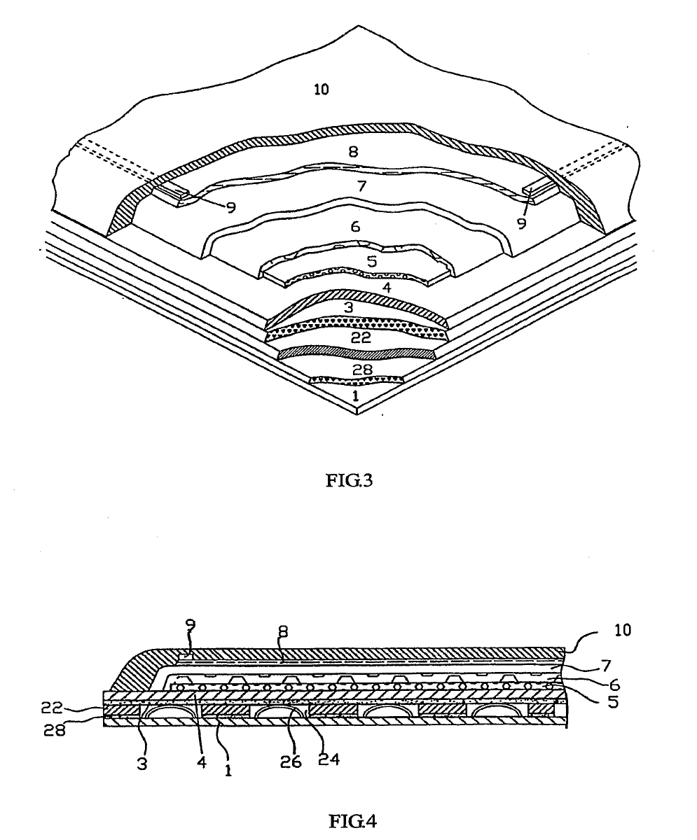

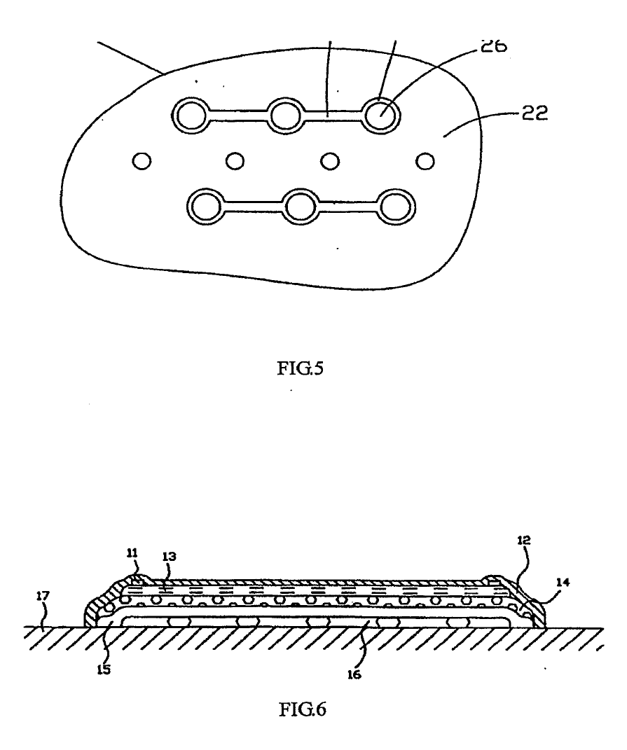

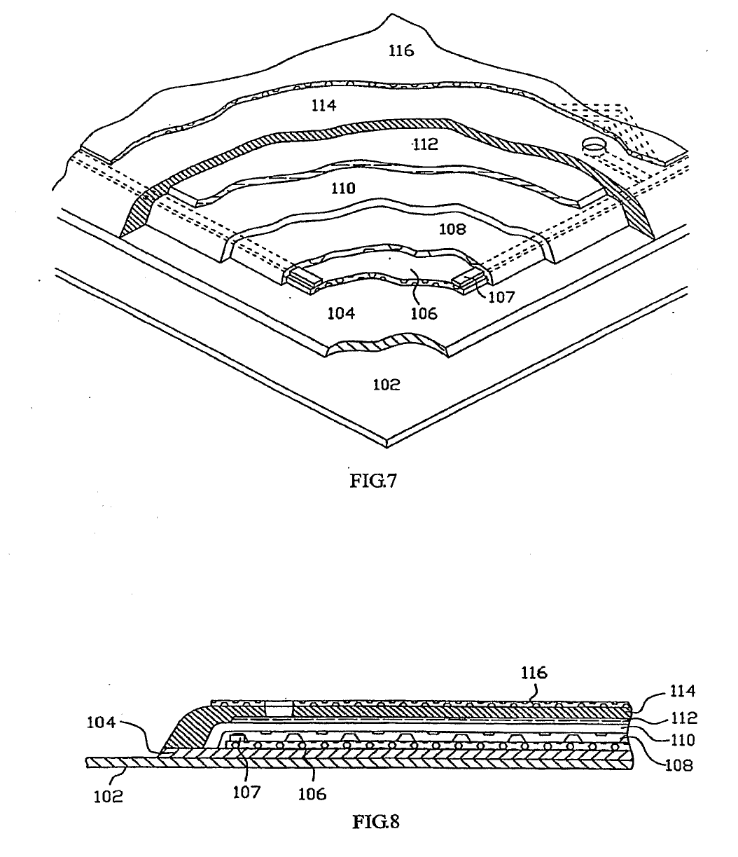

First refer to FIGS. 3 to 5, a combination of an electroluminescent lamp and a metal dome sheet is disclosed, which can be assembled onto the circuit board of a cell phone or other personal communication instruments (Not shown here).

It is provided in this invention a combination of an electroluminescent lamp and a metal dome sheet comprising a rear adhesive protection layer 1, a metal dome sheet 2, a first adhesive layer 3, a substrate 4, a rear electrode layer 5, a dielectric layer 6, a electroluminescent layer 7, a front electrode layer 8, a bus bar 9 and a protection layer 10, from up to down, respectively.

Wherein the first adhesive layer 3 and all the layers over it is identical to those of the electroluminescent lamp mentioned above. These structure will not be discussed herein.

The metal dome sheet 2 comprises a spacer 22 where several circular receiving-grooves 24 are provided and several metal domes 26 in the form of round metal sheet domes seated respectively within the receiving-grooves 24. The receiving-grooves 24 communicate with each other through air escape passages 25. When metal domes 26 are pressed, air can be expelled through air escape passages 25 thereby the feeling of fingers is excellent.

There is also a second adhesive layer 28 beneath the spacer 22. The second adhesive layer 28 is a layer of dryless glue coated directly onto the lower surface of the spacer 22 and placed over the rear adhesive protection layer 21.

The rear adhesive protection layer 21 is on the bottom and designed in the form of a release paper. The rear adhesive protection layer 21 is placed under the second adhesive layer 28 to protect it from outside pollution. Once it is formed, the metal dome sheet 2 can be assembled to the bottom of the first adhesive layer 3 of the electroluminescent lamp to adhere them together.

The release paper could be removed during assembly to expose the second adhesive layer 28 thus the combination of an electroluminescent lamp and a metal dome sheet can be stuck onto electrical products.

According to the combination of an electroluminescent lamp and a metal dome sheet of this invention, the protection layer 10 of the electroluminescent lamp is stuck onto the substrate 4, leaving the electroluminescent system therebetween safely sealed and free of water and dust. The substrate 4 may be mounted onto another products without being removed, therefore, an envelope layer in the prior art can be omitted in this electroluminescent lamp, so manufacturing and material used are simplified. Because of rear adhesive protection layer 21, the combination of the electroluminescent lamp and the metal dome sheet may be transported as an independent product. During assembly, the combination of an electroluminescent lamp and a metal dome sheet can be stuck directly onto other electrical components after the rear adhesive protection layer 21 is removed, which is convenient and time-efficient.

The relative location of the dielectric layer 6 and the electroluminescent layer 7 is interchangeable, i.e. the electroluminescent layer 7 is on the rear electrode layer 5 while the dielectric layer 6 is on the electroluminescent layer 7, and the front electrode layer 8 is on the dielectric layer 6. Of course the bus bar 9 may be omitted if the front electrode layer 8 is highly conductive.

1. An electroluminescent lamp comprising a substrate, an electroluminescent system printed on the substrate and a protection layer covering the outer surface of the electroluminescent system, the electroluminescent system comprising two electrode layers, where a dielectric layer and electroluminescent layer placed there between, characterized in that: the protection layer and the substrate interconnecting to form an envelope layer sealing the electroluminescent system, isolating the electroluminescent system inside the substrate and the protection layer, there being an adhesive layer beneath the substrate.

2. The electroluminescent lamp as claimed in accordance with claim 1, characterized in that: the electroluminescent lamp further comprising a rear adhesive protection layer which is placed under the adhesive layer to protect it from outside pollution.

3. The electroluminescent lamp as claimed in accordance with claim 2, characterized in that: the rear adhesive protection layer being in the form of a release paper and able to be removed during assembly, thus the electroluminescent lamp can be stuck onto electrical products.

4. The electroluminescent lamp as claimed in accordance with claim 1, characterized in that: the adhesive layer being a layer of dryless glue coated directly onto the lower surface of the substrate.

5. The electroluminescent lamp as claimed in accordance with claim 1, characterized in that: said two electrode layers comprising a rear electrode layer and a front electrode layer.

6. The electroluminescent lamp as claimed in accordance with claim 5, characterized in that: the rear electrode layer being super-printed onto the substrate, the dielectric layer being super-printed onto the rear electrode layer, the electroluminescent layer being super-printed onto the dielectric layer, the front electrode layer being super-printed onto the dielectric layer.

7. The electroluminescent lamp as claimed in accordance with claim 5, characterized in that: the rear electrode layer being super-printed onto the substrate, the electroluminescent layer being super-printed onto the rear electrode layer, the dielectric layer being super-printed onto the electroluminescent layer, the front electrode layer being super-printed onto the dielectric layer.

8. The electroluminescent lamp as claimed in accordance with claim 5, characterized in that: at least one bus bar being provided on the front electrode layer to enhance the conductivity of the front electrode layer.

9. The electroluminescent lamp as claimed in accordance with claim 5, characterized in that: the rear electrode layer being printed by silver ink or carbon ink; the dielectric layer being printed by barium titanate; the electroluminescent layer being printed by a mixture of phosphor powder and glue; the front electrode layer being printed by indium tin oxide conductive ink; the bus bar being formed by printing silver-containing ink into a circle of thin line; the protection layer being printed by polyurethane.

10. The electroluminescent lamp as claimed in accordance with claim 1, characterized in that: the substrate being composed of polyester.

11. The electroluminescent lamp as claimed in accordance with claim 2, characterized in that: the electroluminescent lamp being formed by assembling the adhesive layer and the rear adhesive protection layer after printing the electroluminescent system and protection layer onto the substrate.

12. The electroluminescent lamp as claimed in accordance with claim 2, characterized in that: the electroluminescent lamp being formed by direct printing the electroluminescent system and protection layer onto the substrate where the adhesive layer and the rear adhesive protection layer has been placed.

13. A combination of an electroluminescent lamp and a metal dome sheet, the electroluminescent lamp comprising a substrate, an electroluminescent system printed on the substrate and a protection layer covering the outer surface of the electroluminescent system, the electroluminescent system comprising two electrode layers, where a dielectric layer and electroluminescent layer placed there between, characterized in that: the protection layer and the substrate interconnecting to form an envelope layer sealing the electroluminescent system, isolating the electroluminescent system inside the substrate and the protection layer, there being a first adhesive layer beneath the substrate, there being a metal dome sheet beneath the adhesive layer, the metal dome sheet comprising a spacer where several receiving-grooves are provided and several metal domes seated respectively within the receiving-grooves, there being a second adhesive layer beneath the spacer.

14. The combination of an electroluminescent lamp and a metal dome sheet as claimed in accordance with claim 13, characterized in that: the combination of an electroluminescent lamp and a metal dome sheet further comprising a rear adhesive protection layer which is placed under the second adhesive layer to protect it from outside pollution.

15. The combination of an electroluminescent lamp and a metal dome sheet as claimed in accordance with claim 14, characterized in that: the rear adhesive protection layer being in the form of a release paper and able to be removed during assembly thus the second adhesive layer is exposed and the combination of an electroluminescent lamp and a metal dome sheet can be stuck onto a circuit board.

16. The combination of an electroluminescent lamp and a metal dome sheet as claimed in accordance with claim 13, characterized in that: the second adhesive layer being a layer of dryless glue coated directly onto the lower surface of the substrate.

17. The combination of an electroluminescent lamp and a metal dome sheet as claimed in accordance with claim 13, characterized in that: said two electrode layers comprising a rear electrode layer and a front electrode layer.

18. The combination of an electroluminescent lamp and a metal dome sheet as claimed in accordance with claim 17, characterized in that: the rear electrode layer being super-printed onto the substrate, the dielectric layer being super-printed onto the rear electrode layer, the electroluminescent layer being super-printed onto the dielectric layer, the front electrode layer being super-printed onto the dielectric layer.

19. The combination of an electroluminescent lamp and a metal dome sheet as claimed in accordance with claim 17, characterized in that: the rear electrode layer being super-printed onto the substrate, the electroluminescent layer being super-printed onto the rear electrode layer, the dielectric layer being super-printed onto the electroluminescent layer, the front electrode layer being super-printed onto the dielectric layer.

20. The combination of an electroluminescent lamp and a metal dome sheet as claimed in accordance with claim 17, characterized in that: at least one bus bar being formed on the front electrode layer to enhance the conductivity of the front electrode layer.

21. The combination of an electroluminescent lamp and a metal dome sheet as claimed in accordance with claim 13, characterized in that: metal domes being in the formed of round metal sheet domes.

22. The combination of an electroluminescent lamp and a metal dome sheet as claimed in accordance with claim 13, characterized in that: the receiving-grooves being circular and communicating with each other through air escape passages.

23. The combination of an electroluminescent lamp and a metal dome sheet as claimed in accordance with claim 17, characterized in that: the rear electrode layer being printed by silver ink or carbon ink; the dielectric layer being printed by barium titanate; the electroluminescent layer being printed by a mixture of phosphor powder and glue; the front electrode layer being printed by indium tin oxide conductive ink; the bus bar being formed by printing silver-containing ink into a circle of thin line; the protection layer being printed by polyurethane.

24. The combination of an electroluminescent lamp and a metal dome sheet as claimed in accordance with claim 13, characterized in that: the substrate being composed of polyester.

25-46. (canceled)
